(19) United States
(12) Patent Application Publication
(10) Pub. No.: US 2025/0372067 A1
(43) Pub. Date: Dec. 4, 2025

(54) MUSIC GENERATION WITH TIME VARYING CONTROLS

(71) Applicant: Adobe Inc., San Jose, CA (US)

(72) Inventors: Shih-Lun WU, Pittsburgh, PA (US); Nicholas J. BRYAN, Belmont, CA (US)

(73) Assignee: Adobe Inc., San Jose, CA (US)

(21) Appl. No.: 18/680,091

(22) Filed: May 31, 2024

(51) Int. Cl. G10H 1/00; G06F 40/40

(52) U.S. Cl. CPC G10H 1/0025; G06F 40/40; G10H 2210/041; G10H 2210/111

(57) ABSTRACT

Embodiments are disclosed for music generation. The method may include receiving a music prompt and one or more time-varying controls. A text-to-music generative model may generate a representation of music. The text-to-music generative model comprises a pretrained conditional generative model and an adapter control branch. The text-to-music generative model has been fine-tuned to generate the representation of music based on the music prompt and the one or more time-varying controls. The representation of music is converted to music audio and the music audio is output.

### BACKGROUND

Recently, there has been an increase of interest in diffusion models. These models allow for realistic images to be generated based on text prompts. This has enabled creators of varying skill levels to convert high-level intent into images which may then be incorporated into other creative work.

### SUMMARY

Introduced here are techniques/technologies that enable music generation with precise, fine-grained control over time-varying features of the generated music. Diffusion models allow for realistic images to be generated from a text prompt. Such images can include images that represent audio, such as spectrograms. By converting these images back to audio, music can be generated from text prompts using diffusion models.

Embodiments enable generation of music with precise, fine-grained control of time-varying features. In some embodiments, a conditional text-to-music generation model includes a pretrained text-to-music generation model and a control branch. The control branch can include a portion of the pretrained text-to-music generation model, such as an encoder portion, which can be fine-tuned to use time-varying controls.

In particular, a creator may provide a text prompt that defines global features of the music to be generated, such as genre or mood, and time-varying controls that define all or portions of one or more time-varying features of the music to be generated, such as melody, rhythm, dynamics, etc. The time-varying controls may be provided as image data and/or may be extracted from music data. The prompt is provided to the pretrained model, and the prompt and time-varying controls are provided to the control branch. The resulting generated image, e.g., spectrogram, can then be converted into music audio that includes the global features of the text prompt as well as matches the time-varying features of the time-varying controls.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of music generation with time-varying controls in accordance with one or more embodiments;

FIG. 2 illustrates a diagram of a process of music generation with time-varying controls in accordance with one or more embodiments;

FIG. 3 illustrates a diagram of a process of training a text-to-music model with time-varying controls in accordance with one or more embodiments;

FIG. 4 illustrates an example of musical controls in accordance with one or more embodiments;

FIG. 5 illustrates a diagram of a text-to-music model configured to receive a single musical control in accordance with one or more embodiments;

FIG. 6 illustrates a diagram of a text-to-music model configured to receive multiple musical controls in accordance with one or more embodiments;

FIG. 7 illustrates an example of masking musical control data in accordance with one or more embodiments;

FIG. 8 illustrates a schematic diagram of a music generation system in accordance with one or more embodiments;

FIG. 9 illustrates a flowchart of a series of acts in a method of music generation in accordance with one or more embodiments; and

FIG. 10 illustrates a block diagram of an exemplary computing device in accordance with one or more embodiments.

### DETAILED DESCRIPTION

One or more embodiments of the present disclosure include a music generation system which allows for time varying control of the generated audio output. Recently, there has been an increase of interest in text-to-music generative models. These models allow creators to directly convert high-level intent into music audio. This enables creators to generate realistic music without the need to write the music or orchestrate instruments. However, these techniques have limited or no abilities for users to exert time-varying controls (e.g., melody, dynamics, rhythmic patterns) on the generated audio. Such controls are highly valuable as they allow users to interact more closely with the music generation system, thereby improving engagement and allowing users to co-create with AI. Furthermore, such techniques open the door of coordinating generated music with other modalities such as video-control music generation.

There are a number of obstacles for adding precise control to text-based music generation methods. For example, relative to symbolic music representations like scores, text is a cumbersome interface for conveying precise musical attributes that vary over time. Verbose and mundane text descriptions may be needed to precisely represent even the first note of a musical score e.g., “the song starts at 80 beats per minute with a quarter note on middle C played mezzo-forte on the saxophone”. Additionally, text-to-music models tend to faithfully interpret global stylistic attributes (e.g., genre and mood) from text, but struggle to interpret text descriptions of precise musical attributes (e.g., notes or rhythms).

Although there have been prior attempts to address the musical imprecision of natural language, these attempts have come with significant shortcomings. For example, one attempt focuses on synthesizing music audio from time-varying symbolic music representations like MIDI, however this approach offers a particularly strict form of control requiring users to compose entire pieces of music beforehand. Such approaches are more similar to typical music composition processes and do not take full advantage of recent text-to-music methods. Another attempt focuses on musical style transfer which seeks to transform recordings from one style (e.g., genre, musical ensemble, or mood) to another while preserving the underlying composition content. However, a majority of these approaches require training an individual model per style, as opposed to the flexibility of using text to control style in a single model.

To address these and other deficiencies in conventional systems, the music generation system of the present disclosure uses a diffusion-based music generation model that offers multiple time-varying controls over the melody, dynamics, and rhythm of generated audio, in addition to global text-based style control. To incorporate such time-varying controls, embodiments use a ControlNet-style model to enable musical controls that are composable (e.g., can generate music corresponding to any subset of controls) and further allow creators to only partially specify each of the controls both for convenience and to direct the model to musically improvise in remaining time spans of the generation. To overcome the aforementioned scarcity of precise, ground-truth control inputs, embodiments can extract useful control signals directly from music during training.

ControlNet and Uni-ControlNet are image-domain control methods. The ControlNet method proposes an additional control branch to SD diffusion, which has an identical architecture to a pretrained backbone with weights initialized from it, to incorporate the controls. The controls (which should have the same dimensions as the input image) are summed directly with the input image before they enter the control branch to be processed, and finally flow into the pretrained backbone through learned convolutional gates to influence the output. Uni-ControlNet then extends this and enables simultaneously conditioning with multiple controls, by introducing interaction layers for the control signals before they get to the control branch, and multi-layer injection to induce tighter control. Random dropout of controls is used during training so that the model can respond well to any combination of controls.

Embodiments implement a Music ControlNet, a new text-to-music generation model with precise and fine-grained melody, rhythm, and/or dynamics control to enable users to generate music. Embodiments use an image generation backbone diffusion model and includes a modified UniControlNet architecture which integrates multiple music feature extractors to control salient aspects of music including melody, rhythm, and dynamics/intensity.

When applying such image domain techniques to music generation, new control signals are used to control melody, rhythm, and/or dynamics. However, these audio controls have less direct correlation with image features (e.g., Canny edge, semantic segmentation map, pose skeleton, etc.). Therefore, a lightweight feedforward neural network is added to the model to nonlinearly transform each control signal before they reach the control branch. Furthermore, embodiments enable compositional time-varying control with 12 ms resolution and can easily be extended with additional control signals such as instrument control, mood control over time, and more.

Further, embodiments allow a user to provide partial control, where the model will then improvise the rest. For example, regions of the control signals can be set to a special null value during training, so the model learns that it should adhere to control on some regions, but not others. This approach allows for partial control signals (e.g., partial melodies, etc.) and empowers the model to improvise the unspecified control regions. This allows the model to learn how to generate melodies with accompaniment directly from mixture recordings via self-supervised feature extraction and diffusion training as opposed to learn directly on symbolic melody information.

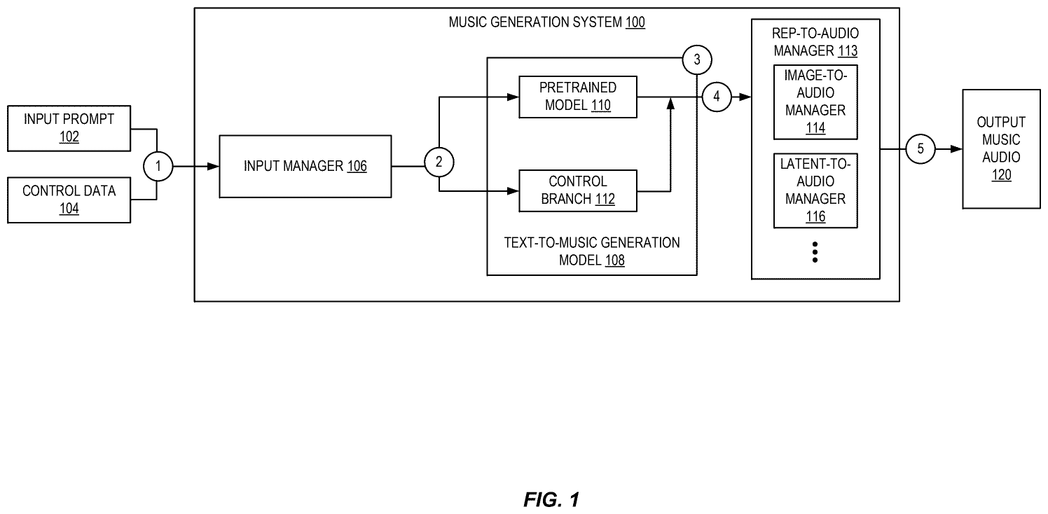

FIG. 1 illustrates a diagram of a process of music generation with time-varying controls in accordance with one or more embodiments. As shown in FIG. 1, a music generation system 100 can generate music audio data based on an input prompt and control data. In some embodiments, the music generation system 100 may be implemented as a service executing on a server as part of a cloud computing model. Additionally, or alternatively, the music generation system may be implemented as an application executing locally on a user's computing device(s). In some embodiments, portions of the music generation system 100 may be implemented locally and may send requests (e.g., calls, etc.) for some processing to be performed remotely. In some embodiments, the music generation system 100 may be implemented as a standalone application, as a tool incorporated within another application, or as part of a suite of applications or services.

At numeral 1, an input prompt 102 and control data 104 are received by input manager 106. The input prompt 102 may be a text prompt (e.g., a natural language prompt) which describes a style, genre, mood, etc. for the music to be generated. This represents a global control, which controls the overall style, genre, mood, etc. of the generated music. The control data may include time varying controls which define all or portions of time varying features, such as melody, rhythm, dynamics, etc. In some embodiments, the control data may take different forms depending on the type of data it represents. For example, melody data may be provided in a frequency representation, such as a Chromagram, rhythm data may be represented in activation curves from a beat detector, and dynamics may be represented in a root-mean-square (RMS) energy waveform. In some embodiments, the time-varying controls may be extracted from a control audio data provided by the user. As discussed further, in some embodiments, portions of the time-varying controls may be masked, allowing for the model to improvise those portions of the time varying controls while matching the unmasked portions.

At numeral 2, the input manager 106 can provide the appropriate inputs to the text-to-music generation model 108. As shown, the text-to-music generation model 108 can include a pretrained model 110 and a control branch 112. The pretrained model 110 may be a diffusion model. In this instance, the diffusion model is pretrained to generate a spectrogram of audio data, such as a Mel spectrogram, based on an input text prompt. A diffusion model may include one or more neural networks trained to generate an image by iteratively denoising random noise based on the text input.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, e.g., machine learning that utilizes a set of algorithms to attempt to model high-level abstractions in data.

As shown in FIG. 1, the pretrained model 110 receives the input prompt 102 and the control branch 112 receives the input prompt 102 and the control data 104. At numeral 3, the pretrained model 110 and control branch 112 process their respective inputs. The output of the control branch 112 is combined with the output of the pretrained model 110 to create the final output. This allows the control branch to be fine-tuned for time-varying controls without affecting the pretrained model. Additionally, as discussed further, a single control branch can be used for all supported control data types, rather than requiring multiple control branches, one for each possible control data type.

At numeral 4, the final output of the text-to-music generation model 108 is provided to representation-to-audio manager 113. In various embodiments, the text-to-music generation model may generate a representation of music from a text input. The representation may include an image representation, such as a spectrogram, a latent representation, or other representation. In some embodiments, the representation-to-audio manager 113 may include a plurality of managers, such as an image-to-audio manager 114, a latent-to-audio manager 116, etc., which are responsible for converting the generated representation into output audio. For example, when the output of the text-to-music generation model 108 is an image representation of the output audio, such as a Mel-spectrogram or other spectrogram, it is processed by the image-to-audio manager 114. The spectrogram data can be converted into audio using image-to-audio manager 114, which outputs the generated music audio 120 at numeral 5. Alternatively, if the output of the text-to-music generation model 108 is a latent representation of the output audio, then it is processed by the latent-to-audio manager 116. Although the example of FIG. 1 shows the representation-to-audio manager 113 as including multiple different managers, in some embodiments, any particular deployment of the representation-to-audio manager 113 may only include managers corresponding to the type(s) of output(s) supported by the text-to-music generation model 108.

As discussed, in some embodiments, a diffusion model is used to generate an image representation of audio and then this representation is converted to sound to obtain the generated audio. Alternatively, in some embodiments, an autoencoder is used to learn a latent space of audio and then use a diffusion model is used to generate “latents” or tensors in the latent space of audio. The generated latents can then be decoded back into the audio (or image domain) using the latent-to-audio manager 116 (e.g., which may include the autoencoder decoder block).

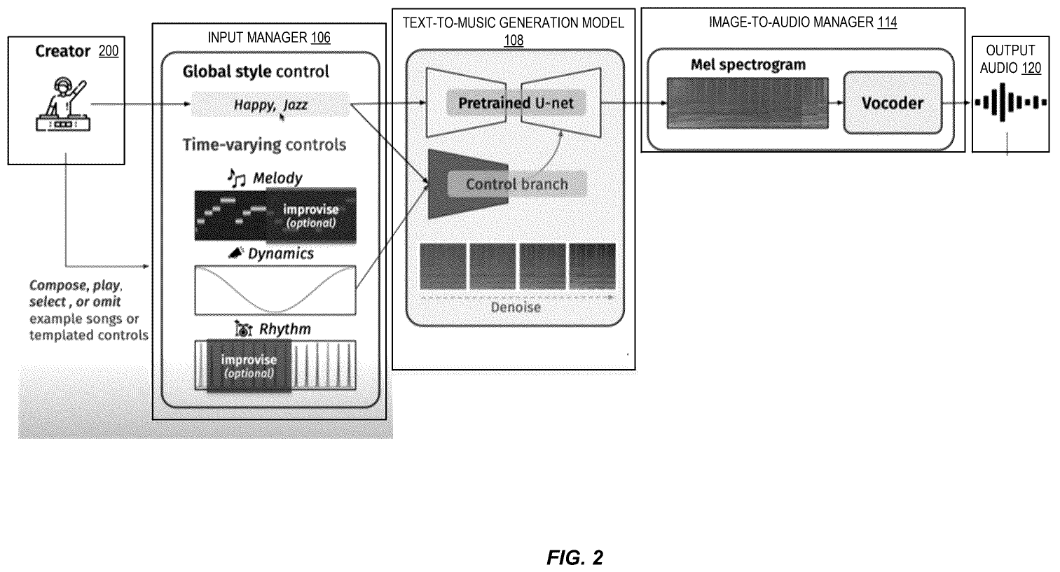

FIG. 2 illustrates a diagram of a process of music generation with time-varying controls in accordance with one or more embodiments. As discussed, a creator 200 can generate music with time-varying controls using music generation system 100. For example, as shown in FIG. 2, the creator 200 can provide a text prompt that defines a global style of the music to be generated. In this instance, the text prompt is “Happy, Jazz” so the text-to-music generation model 108 will generate music in the style of jazz that evokes happiness (e.g., upbeat, major key, etc.). Additionally, the creator 200 provides one or more time-varying controls. In this example, the time-varying controls include melody, dynamics, and rhythm. The creator may provide these by composing a short melody, playing an existing audio snippet, using a template, etc. The time-varying controls may then be extracted from the audio provided by the creator. Alternatively, or additionally, the creator may provide the time-varying controls having been extracted outside the music generation system and/or having been created natively in a form that can be processed by the text-to-music generation model 108.

As shown in FIG. 2, the text-to-music generation model includes a pretrained diffusion model 108, such as a pretrained U-Net including an encoder and a decoder, and a control branch. The pretrained model receives the text prompt and the control branch receives the text prompt and the time-varying controls. In some embodiments, the pretrained diffusion model may be a denoising diffusion probabilistic model (DDPM). DDPMs are a class of latent generative variable model. A DDPM generates data x⁽⁰⁾ ∈χ from Gaussian noise x^{(M)} ∈χ through a denoising Markov process that produces intermediate latents x^{(M-1)}, x^{(M-2)}, . . . , x⁽¹⁾ ∈χ, where χ is the data space. DDPMs can be formulated as the task of modeling the joint probability distribution of the desired output data x⁽⁰⁾ and all intermediate latent variables, e.g.,

$${p}_{θ} ( {x}^{( 0 )} , … , {x}^{( M )} ) := p ( {x}^{( M )} ) {\prod }_{m = 1}^{M} {p}_{θ} ( {x}^{( m - 1 )} \vert {x}^{( M )} )$$

where θ denotes the set of parameters to be learned, and p(x^{(M)}):= [symbol] (0, l).

To create training examples, a forward diffusion process q(x⁽⁰⁾, . . . , x^{(M)}) is used to gradually corrupt clean data examples x⁽⁰⁾ via a Markov chain that iteratively adds noise:

$$q ( {x}^{( 0 )} , … , {x}^{( M )} ) := q ( {x}^{( 0 )} ) {\prod }_{m = 1}^{M} q ( {x}^{( m )} \vert {x}^{( m - 1 )} ) \\ q ( {x}^{( m )} \vert {x}^{( m - 1 )} ) := 𝒩 ( \sqrt{1 - {β}_{m}} {x}^{( m - 1 )} , {β}_{m} I )$$

where q(x⁽⁰⁾) is the true data distribution, and β₁, . . . β_{M} are a sequence of parameters that define the noise level within the forward diffusion process, also known as the noise schedule.

By definition of q(x^{(m)}|x^{(m-1)}), it follows that the noised data x^{(m)} at any noise level m∈{1, . . . , M} can be sampled in one step via:

$${x}^{( m )} := \sqrt{{\overline{α}}_{m}} {x}^{( 0 )} + \sqrt{1 - {\overline{α}}_{m}} ϵ$$

where

$${\overline{α}}_{m} := {\prod }_{{m}^{′} = 1}^{m} ( 1 - {β}_{{m}^{′}} ) , ϵ ∼ 𝒩 ( 0 , I ) ,$$

and M is the total number of noise levels or steps during training. The variational lower bound of the data likelihood can be optimized, e.g., p_{θ}(x⁽⁰⁾), by training a function approximator, e.g., a neural network, f_{θ}(x^{(M)}, m) χ× [symbol] →χ to recover the noise ϵ, added as described above. More specifically, f_{θ}(x^{(M)}, m) can be trained by minimizing the mean squared error, e.g.,

$${𝔼}_{{x}^{( M )} , ϵ , m} [ {‖ ϵ - {f}_{θ} ( {x}^{( M )} , m ) ‖}_{2}^{2} ]$$

With a trained f_{θ}, random noise can be transformed x^{(M)}˜ [symbol] (0, l) to a realistic data point x⁽⁰⁾ through M denoising iterations. To obtain high-quality generations, a large M (e.g., 1000) is typically used. To reduce computational cost, denoising diffusion implicit models (DDIM) further proposed an alternative formulation that allows running much fewer than M sampling steps (e.g., 50-100) at inference with minimal impact on generation quality.

As shown in FIG. 2, in some embodiments the function, f_{θ}, (e.g., the pretrained model) may be a large U-Net. The U-Net architecture includes two halves, an encoder and a decoder, that typically input and output image-like feature maps in the pixel space or some learned latent space. The encoder progressively downsamples the input to learn useful features at different resolution levels, while the decoder, which has a mirroring architecture to the encoder and accepts features from corresponding encoder layers through skip connections, progressively upsamples the features to eventually get back to the input dimension. For practical use, diffusion-based image generation models are often text-conditioned, which requires augmenting the network f_{θ} to accept a text description cₜₑₓₜ ∈ [symbol] , where [symbol] is the set of all text descriptions. This leads to the following function signature:

$${f}_{θ} ( {x}^{( M )} , m , {c}_{text} ) : 𝒳 \times ℕ \times 𝒯 \to 𝒳$$

which models the desired probability distribution p_{θ}(x⁽⁰⁾|cₜₑₓₜ). The text condition cₜₑₓₜ is typically a sequence of embeddings from a large language model (LLM) or one or more embeddings from a learned embedding layer for class-conditional control. In either case, the conditioning signals m (e.g., the diffusion time step) and cₜₑₓₜ can be incorporated in the U-Net hidden layers via additive sinusoidal embeddings and/or cross-attention.

As shown in FIG. 2, time varying controls may include melody, dynamics, rhythm, or other time-varying musical features. As discussed, embodiments add time-varying controls through the use of control branch 112. This allows for embodiments to learn a conditional generative model p(w|cₜₑₓₜ, C) over audio waveforms w, given a global (e.g., time-independent) text control cₜₑₓₜ, and a set of time-varying controls C. In some embodiments, cₜₑₓₜ may include musical genre and moods tags. Waveforms, w, may include vectors in [symbol] ^{Tfs}, where T is the length of audio in seconds and fₛ is the sampling rate (e.g., number of samples per second). As fₛ is large (typically between 16 kHz and 48 kHz), it can be empirically difficult to directly model p(w|⋅). Hence, embodiments adopt a hierarchical approach of using spectrograms as an intermediary. A spectrogram s∈ [symbol] ^{Tf}^{ₖ}^{×B×D} is an image-like representation for audio signals, obtained through Fourier Transform on w, where fₖ is the frame rate (usually 50-100 per second), B is the number of frequency bins, and D=1 for mono-channel audio. The task of modeling waveforms w, can be factorized as:

$$p ( w , s \vert {c}_{text} , C ) = p ( w \vert s , {c}_{text} , C ) \cdot p ( s \vert {c}_{text} , C ) := {p}_{ϕ} ( w \vert s ) \cdot {p}_{θ} ( s \vert {c}_{text} , C )$$

where ϕ and θ are sets of parameters to be learned, assuming conditional independence between waveform w and all control signals cₜₑₓₜ and C given spectrogram s.

As shown in FIG. 2, the control branch can include a copy of the encoder portion of the pretrained model. As discussed further below, this enables pixel level control of the output image via fine-tuning. To gracefully bring in the information from pixel-level control, it enters the control branch through a convolution layer that is initialized to zeros (e.g., a zero convolution layer). Outputs from layers of the control branch are then fed back to the corresponding layers of the frozen pretrained decoder, also through zero convolution layers, to influence the final output. The control branch is then augmented such that one model can be finetuned to accept multiple pixel-level controls via a single adaptor branch without the need to specify all controls at once whereas prior implementations of ControlNet have required separate adaptor branches per control.

The text-to-music generation model outputs a representation of the generated music. As discussed, this representation may include an image representation, such as a Mel spectrogram, a latent representation, or other representation of the generated music. In the example of FIG. 2, an image representation of the generated music has been generated. The image-to-audio manager 114 then converts the Mel spectrogram into output audio 120 using a vocoder, as shown in FIG. 2.

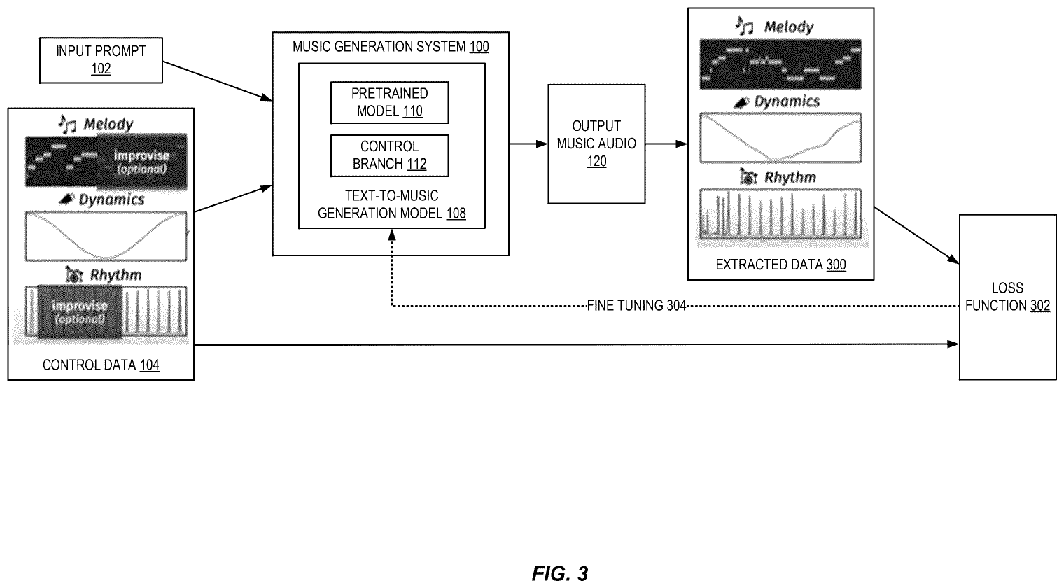

FIG. 3 illustrates a diagram of a process of training a text-to-music model with time-varying controls in accordance with one or more embodiments. As shown in FIG. 3, the time-varying features of the output audio corresponding to the time-varying controls received as input can be extracted from the generated output audio 120. This extracted data 300 can then be compared to the input control data 104 using a loss function 302.

Given the pretrained global style control model (e.g., pretrained model 110), embodiments finetune on time-varying melody, dynamics, and rhythm controls. The time-varying controls enter the pretrained model via a control branch as discussed above. In some embodiments, the same loss 302 and optimizer used for pretraining can be used for finetuning until convergence.

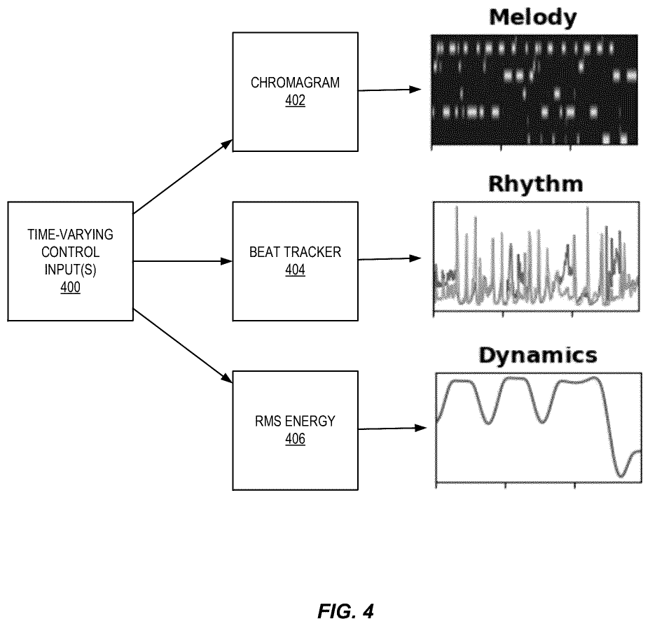

FIG. 4 illustrates an example of musical controls in accordance with one or more embodiments. These controls can be directly extracted from a target spectrogram, requiring no human annotation, and allow music creators to easily create their control signals at inference time to compose their music from scratch, in addition to remixing, e.g., combining musical elements from different sources, using controls extracted from existing music.

As shown in FIG. 4, the user may provide one or more time-varying control inputs. These may then be used to obtain the time varying control data to be used in audio generation. For example, the user may provide a different audio snippet for each time-varying control which may be extracted from the corresponding snippet. For example, in FIG. 4, a chromagram 402 representing the melody of the time-varying control. This may be obtained by high-pass filtering the control and performing a frame-wise argmax over 12 pitch classes. In some embodiments, a beat tracker 404 may be used to determine the rhythm of the control and the root-mean-square (RMS) energy 406 may be used to determine the dynamics of the control.

As discussed, for melody

$$( e . g . , {c}_{mel} ∈ {ℝ}^{{T}_{{f}_{k}} \times 12 \times 1} )$$

a variation of chromagram may be used to encode the most prominent musical tone over time. To do so, embodiments compute a linear spectrogram and then rearrange the energy across the B frequency bins into 12 pitch classes (or semitones, e.g., C, C-sharp, . . . , B-flat, B) in a frame-wise manner, e.g., independently for each t∈{1, . . . , T_{f}_{ₖ}}, via the Librosa Chroma function. To form a better proxy for melody from the raw chromagram, only the most prominent pitch class is preserved by applying an argmax operation to make the chromagram frame-wise one-hot. Additionally, embodiments apply a Biquadratic high-pass filter with a cut-off at Middle C, or 261.2 Hz before chromagram computation to avoid bass dominance, e.g., the resulting one-hot chromagram encodes the bass notes, rather than the desired melody notes. At inference time, the melody control can be created by recording a simple melody, or simply drawing the pitch contour.

For dynamics

$$( {c}_{dy n} ∈ {ℝ}^{{T}_{{f}_{k}} \times 1 \times 1} ) ,$$

a dynamics control can be obtained by summing the energy across frequency bins per time frame of a linear spectrogram, and mapping the resulting values to the decibel (dB) scale, which is closely linked to loudness perceived by humans. To mitigate rapid fluctuations of the raw dynamic values due to note or percussion onsets, and also to bring the dynamics control closer to the perceived musical intensity, embodiments apply a smoothing filter with one second context window over the frame-wise values (e.g., a Savitzky-Golay filter). The dynamics control not only characterizes the loudness of notes, but also is strongly correlated with important musical intensity-related attributes like instrumentation, harmonic texture, and rhythmic density thanks to the natural correlation between loudness and the aforementioned attributes in human-composed music. During inference, creators can simply draw a line/curve of how they want the musical intensity to vary over time as the created dynamics control.

For rhythm

$$( {c}_{rhy} ∈ {ℝ}^{{T}_{{f}_{k}} \times 2 \times 1} ) ,$$

control, embodiments employ an RNN-based beat detector that is trained on a rhythm dataset to predict whether a frame is situated on a beat, a downbeat, or neither. Embodiments then use the frame-wise beat and downbeat probabilities for control, resulting in 2 classes per frame. The advantages of using a time-varying beat/downbeat control over just inputting a global tempo (e.g., beats per minute) include allowing creators to precisely synchronize beats/downbeats with, for example, video scene cuts or other moments of interest in the content to be paired with generated music. Additionally, it also encodes some nuanced information of rhythmic feeling, e.g., whether the music sounds more harmonic or rhythmic, and whether the rhythmic pattern is clear/simple, or complex, on which experienced music creators may want to influence in the generative process. At inference, the rhythm control can be created by time-stretching the beat/downbeat probability curves extracted from existing songs to match the desired tempo. Also, creators can obtain precise beat/downbeat timestamps by feeding the beat/downbeat curves to a Hidden Markov Model (HMM) based post-filter, and use the timestamps to shift the curves along the time axis for synchronization purposes mentioned above.

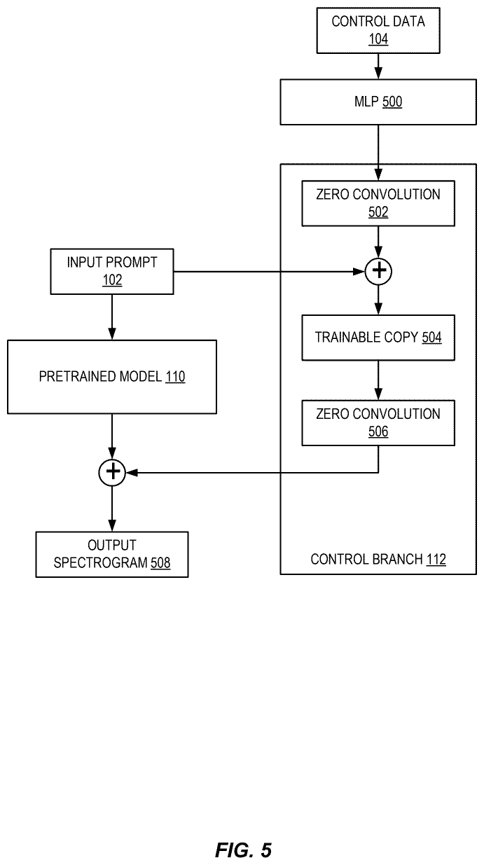

FIG. 5 illustrates a diagram of a text-to-music model configured to receive a single musical control in accordance with one or more embodiments. As shown in FIG. 5, time-varying controls can be added to a diffusion model by adding a control branch 112 to the pretrained model 110. The input prompt 102 can be provided to both the pretrained model and the control branch and the control branch can also receive control data 104.

As discussed, embodiments model spectrograms given controls, e.g., p_{θ}(s|cₜₑₓₜ, C), and directly apply a vocoder to model p_{ϕ}(w|s). Following the text-to-image model, diffusion models are used to learn p_{θ}(s|cₜₑₓₜ, C). If the input space is set to χ:= [symbol] ^{Tf}^{ₖ}^{×B×D}, and the desired output x⁽⁰⁾:=s, then a neural network f_{θ} can be instantiated having an identical function signature to that described above (e.g., f_{θ}(x^{(M)}, m, cₜₑₓₜ):χ× [symbol] × [symbol] →χ). However, pixel-level controls for images and time-varying controls for audio/music present different challenges with respect to how they should be applied to the output.

For example, the first two dimensions in a spectrogram s have different semantic meanings, one being time and the other being frequency, as opposed to both being spatial in an image. Additionally, the time-varying controls useful to creators are closely coupled with time, but could have a much more relaxed relationship with frequency such that the second dimension cannot be restricted to B. For example, an intuitive control over ‘musical dynamics’ may involve defining volume over time, but not over frequency. A high dynamics value for one frame can mean a number of different profiles over the B frequency bins for the corresponding spectrogram frame, e.g., a powerful bass playing a single pitch, or a rich harmony of multiple pitches, which the model has freedom to decide. Therefore, we relax the definition for the set of N control signals to become:

$$C := {\{ {c}^{( n )} ∈ {ℝ}^{T {f}_{k} \times {B}_{n} \times {D}_{n}} \}}_{n = 1}^{N}$$

where Bₙ is the number of classes specific to each control c⁽ⁿ⁾, which is not bound to B. With this updated definition, the correspondence between control signals C and the output spectrogram x becomes frame-wise. For example, suppose c⁽ⁿ⁾ represents dynamics control, a frame for the control c⁽ⁿ⁾ ∈ [symbol] ^{1×1}, where t∈{1, . . . , Tfₖ}, then describes “the musical dynamics (intensity) of the spectrogram frame sₜ”.

In some embodiments, time-varying controls c⁽ⁿ⁾ can be directly extracted from spectrograms. Given that spectrograms are also computed directly from waveforms, only pairs of (w, cₜₑₓₜ) are used for training, causing no extra annotation overhead. Nevertheless, manually annotated time-varying controls may be used as well.

Embodiments learn the mapping between input controls and the frequency axis of output spectrograms. As discussed, the control branch 112 can include a copy (e.g., a “clone”) of a portion of the pretrained model 110. For example, where the pretrained model is a U-Net, the encoder may be copied for use in the control branch. The control branch also includes newly attached zero convolution layers 502, 506 to enable pixel-level control. Let \tilde{f}^{(l)}(x^{(m,l-1)}, m, cₜₑₓₜ, C) denote the lth block of the control branch, where m is the diffusion time step, x^{(m,l-1)} includes the features of the noised image after l−1 blocks, and cₜₑₓₜ, C are the text and pixel-level controls respectively. Considering the case C:={c⁽¹⁾}, the pixel-level control is incorporated via:

$${\tilde{f}}^{( l )} ( {x}^{( m , l - 1 )} , m , {c}_{text} , C ) := {𝒵}_{out} ( {f}^{( l )} ( {x}^{( m , l - 1 )} + {𝒵}_{i n} ( {c}^{( 1 )} ) , m , {c}_{text} ) )$$

where χᵢₙ and χₒᵤₜ are the zero convolution layers 502, 506, and f(l) is initialized from the lth encoder block of the pretrained text-conditioned U-Net.

For music control, this control process can be further modified to be:

$${\tilde{f}}^{( l )} ( {x}^{( m , l - 1 )} , m , {c}_{text} , C ) := {𝒵}_{out} ( {f}^{( l )} ( {x}^{( m , l - 1 )} + {𝒵}_{i n} ( ℳ ( {c}^{( 1 )} ) ) , m , {c}_{text} ) )$$

where [symbol] is an additional 1-hidden-layer multilayer perceptron (MLP) that transforms B₁, the number of classes for the control c⁽¹⁾ to match the number of frequency bins B, and simultaneously learns the relationship between control classes and frequency bins.

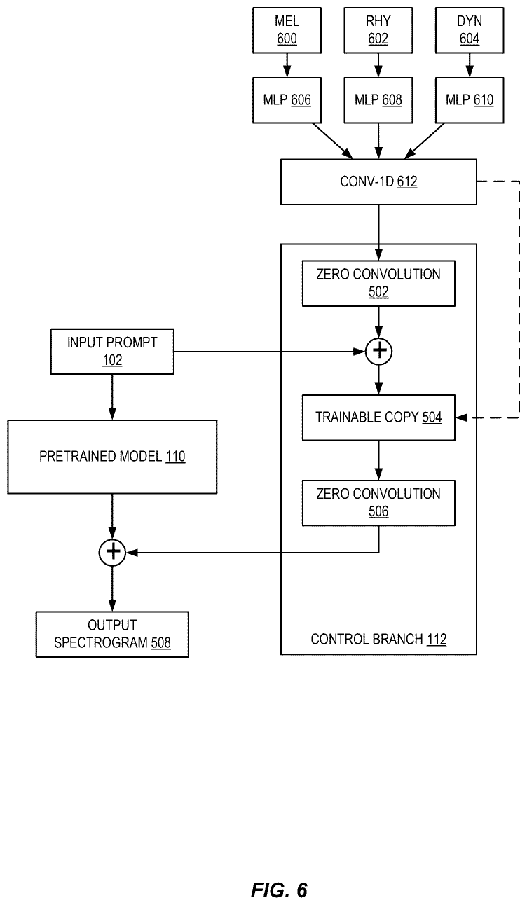

FIG. 6 illustrates a diagram of a text-to-music model configured to receive multiple musical controls in accordance with one or more embodiments. As shown in FIG. 6, in cases with multiple controls, e.g.,

$$C = {\{ {c}^{( n )} \}}_{n = 1}^{N} ,$$

each control is processed with its individual MLP, e.g., [symbol] ⁽ⁿ⁾, and then concatenated along the depth dimension, e.g., Dₙ, before entering the shared zero-convolution layer χᵢₙ 502. For example, FIG. 6 shows three controls: melody 600, rhythm 602, and dynamics 604. Each control is associated with its own MLP 606-610. The outputs of the MLPs are then received by conv-1D layer 612 before being provided to the χᵢₙ 502.

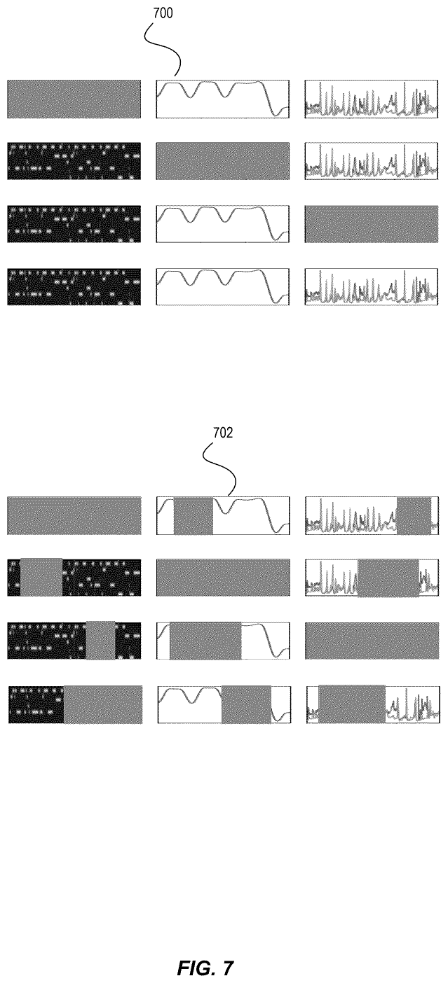

FIG. 7 illustrates an example of masking musical control data in accordance with one or more embodiments. One technique to improve the flexibility of text conditioning is classifier-free guidance (CFG). CFG is used to simultaneously learn a conditional and unconditional generative model together and trade-off conditioning strength, mode coverage, and sample quality. Practically speaking, during training CFG is achieved by randomly setting conditioning information to a special null value c_{Ø} for a fraction of the time during training. An example of such masked data is shown in FIG. 7 at 700. As shown, one control in each set of controls is completely masked out. Then during inference, an image is generated using conditional control inputs, unconditional control inputs, or a linear combination of both. In most cases, a forward pass of f_{θ}(x^{(m)}, m, cₜₑₓₜ) and f_{θ}(x^{(m)}, m, c_{Ø}) per sampling step are needed and subsequent weighted averaging.

To give creators the freedom to input any subset of the N controls, Uni-ControlNet proposed a CFG-like training strategy to drop out each of the control signals c⁽ⁿ⁾ randomly during training. Embodiments employ a similar strategy and further assign a higher probability to keep or drop all controls as this was found to lead to perceptually better generations. In more detail, embodiments let the index set of control signals be [symbol] {1, . . . , N}. At each training step, w a subset [symbol] ⊆ [symbol] is selected that will be set to zero or dropped. The index subset is then applied directly to the control signals via:

$${c}^{( n )} := \{ \begin{matrix}{0}_{{T}_{{f}_{k}} \times {B}_{n} \times {D}_{n} ∀ n ∈ {𝒥}^{′}} \\ {c}^{( n )} ∀ n ∈ 𝒥 \backslash {𝒥}^{′}\end{matrix}$$

Doing so induces f_{θ}(x^{(m)}, m, cₜₑₓₜ, C) to learn the correspondence between any subset of the N control signals and the output spectrogram.

However, unlike prior techniques, the text-to-music generation model allows for controls to be partially-specified in time. That is, rather than nulling an entire control, just a portion of the control may be masked. Accordingly, embodiments implement a windowing scheme that partially masks the active controls (e.g., those indexed by [symbol] ) Specifically, embodiments randomly sample a pair (t_{n,a}, t_{n,b})∈{1, . . . , T_{f}_{ₖ}}², where t_{n,a}<t_{n,b}, for each of the active controls, and mask them as:

$${c}_{t}^{( n )} := \{ \begin{matrix}{0}_{{B}_{n} \times {D}_{n} if t ∈ [ {t}_{n , a} , {t}_{n , b} ]} \\ {c}_{t}^{( n )} otherwise\end{matrix} ∀ n ∈ 𝒥 \backslash {𝒥}^{′}$$

FIG. 7 shows these masking schemes that may be applied during training that allow creators to input any subset of the time-varying controls, fully or partially specified in time, at inference. Each row indicates a unique masking instantiation over the set of control signals

$$C := {\{ {c}^{( n )} \}}_{n = 1}^{N}$$

(N=3 as illustrated in FIG. 7). Masked control signals are colored in gray. As discussed, at 700, at least one entire control signal is masked out. At 702, however, a portion of each control signal is masked out. Although each control signal at 702 shows a portion masked out, in some embodiments not every control signal will be masked. For example, only a portion of one control signal may be masked. Additionally, in the example of 702, the masked portion of each control signal is a single contiguous portion. In some embodiments, multiple distinct portions of a control signal may be masked out.

As shown in FIG. 7, at each training step, after selecting [symbol] (e.g., determining the dropped controls) one of the two masking schemes is chosen at random, and then the timestamp pairs are sampled (e.g., (t_{n,a}, t_{n,b})'s) when needed. In this way, a CFG-like training strategy is employed to enable partially-specified controls in a unified manner.

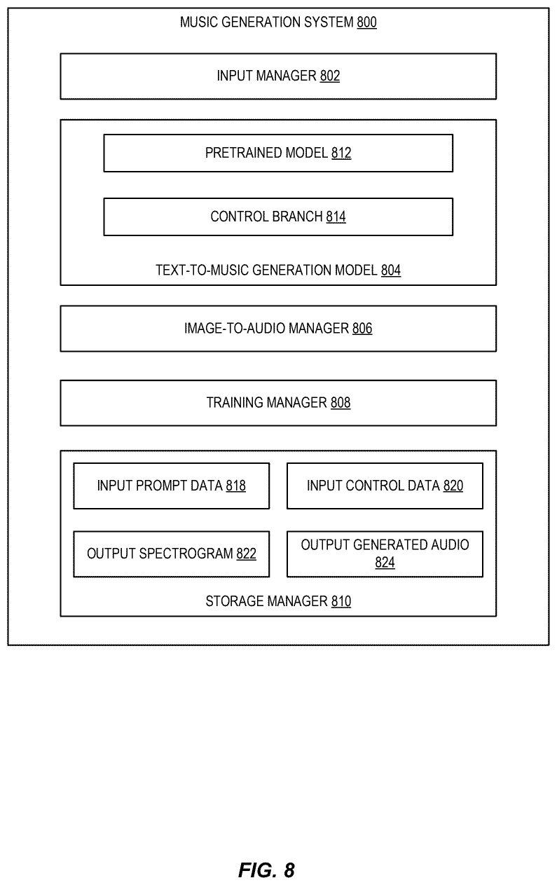

FIG. 8 illustrates a schematic diagram of music generation system (e.g., “music generation system” described above) in accordance with one or more embodiments. As shown, the music generation system 800 may include, but is not limited to, input manager 802, text-to-music generation model 804, image-to-audio manager 806, training manager 808, and storage manager 810. The text-to-music generation model 804 includes a pretrained model 812 and a control branch 814. The storage manager 810 includes input prompt data 818, input control data 820, output spectrogram 822, and output generated audio 824.

As illustrated in FIG. 8, the music generation system 800 includes an input manager 802. For example, the input manager 802 allows users to provide input prompt and control data to the music generation system 800. In some embodiments, the input manager 802 provides a user interface through which the user can enter the input prompt data 818 and/or upload the input control data 820 which represent target time-varying features to be generated, as discussed above. Alternatively, or additionally, the user interface may enable the user to download or otherwise obtain the input prompt and/or control data from a local or remote storage location (e.g., by providing an address (e.g., a URL or other endpoint) associated with a data source). In some embodiments, the user interface can enable a user to link an audio capture device, such as a microphone or other hardware to capture music data and provide it to the music generation system 800 from which control data may be extracted.

As illustrated in FIG. 8, the music generation system 800 includes a text-to-music generation model 804. The text-to-music generation model 804 may be a diffusion model configured to generate image data from a text prompt. In particular, the text-to-music generation model 804 may be a ControlNet-style model that includes a pretrained model 812 that has been pretrained to generate a representation of music based on a text prompt. The image representation may be a Mel spectrogram or similar representation. As discussed, to facilitate time-varying controls, the text-to-music generation model 804 may include a control branch 814 which can be fine-tuned to enable pixel-level control based on one or more time-varying controls, such as data representing melody, rhythm, dynamics, etc.

In some embodiments, the text-to-music generation model 804 is implemented in a neural network manager. A neural network manager may host a plurality of neural networks or other machine learning models. The neural network manager may include an execution environment, libraries, and/or any other data needed to execute the machine learning models. In some embodiments, the neural network manager may be associated with dedicated software and/or hardware resources to execute the machine learning models.

As illustrated in FIG. 8 the music generation system 800 also includes training manager 808. The training manager 808 can teach, guide, tune, and/or train one or more neural networks. In particular, the training manager 808 can train a neural network based on a plurality of training data. For example, the text-to-music generation model 804 (e.g., in particular, control branch 814, which may include a copy of a portion of the pretrained model) may be fine-tuned to generate an image based on time-varying controls, as discussed. Additionally, the text-to-music generation model 804 may be further optimized using loss functions, as discussed above, by backpropagating gradient descents. More specifically, the training manager 808 can access, identify, generate, create, and/or determine training input and utilize the training input to train and fine-tune a neural network.

As illustrated in FIG. 8, the music generation system 800 also includes the storage manager 810. The storage manager 810 maintains data for the music generation system 800. The storage manager 810 can maintain data of any type, size, or kind as necessary to perform the functions of the music generation system 800. The storage manager 810, as shown in FIG. 8, includes the input prompt data 818. The input prompt data 818 can include text prompt describing global features of the audio to be generated, such as mood, genre, etc., as discussed in additional detail above.

As further illustrated in FIG. 8, the storage manager 810 also includes input control data 820. Input control data 820 can include time-varying control data, such as melody, rhythm, dynamics, etc. to be used for generating music, as discussed above. In some embodiments, the input control data can include audio data from which the controls (e.g., chromagram, beat data, RMS energy, etc.) can be extracted. Additionally, in some embodiments, all or portion(s) of an individual control may be masked, as discussed above.

The storage manager 810 may also include output spectrogram 822. The output spectrogram 822 may include an image generated by the text-to-image generation model that represents audio data, such as a Mel spectrogram. As discussed, the image may be converted into audio using the image-to-audio manager 806, which produces output generated audio 824.

Each of the components 802-810 of the music generation system 800 and their corresponding elements (as shown in FIG. 8) may be in communication with one another using any suitable communication technologies. It will be recognized that although components 802-810 and their corresponding elements are shown to be separate in FIG. 8, any of components 802-810 and their corresponding elements may be combined into fewer components, such as into a single facility or module, divided into more components, or configured into different components as may serve a particular embodiment.

The components 802-810 and their corresponding elements can comprise software, hardware, or both. For example, the components 802-810 and their corresponding elements can comprise one or more instructions stored on a computer-readable storage medium and executable by processors of one or more computing devices. When executed by the one or more processors, the computer-executable instructions of the music generation system 800 can cause a client device and/or a server device to perform the methods described herein. Alternatively, the components 802-810 and their corresponding elements can comprise hardware, such as a special purpose processing device to perform a certain function or group of functions. Additionally, the components 802-810 and their corresponding elements can comprise a combination of computer-executable instructions and hardware.

Furthermore, the components 802-810 of the music generation system 800 may, for example, be implemented as one or more stand-alone applications, as one or more modules of an application, as one or more plug-ins, as one or more library functions or functions that may be called by other applications, and/or as a cloud-computing model. Thus, the components 802-810 of the music generation system 800 may be implemented as a stand-alone application, such as a desktop or mobile application. Furthermore, the components 802-810 of the music generation system 800 may be implemented as one or more web-based applications hosted on a remote server. Alternatively, or additionally, the components of the music generation system 800 may be implemented in a suite of mobile device applications or “apps.”

As shown, the music generation system 800 can be implemented as a single system. In other embodiments, the music generation system 800 can be implemented in whole, or in part, across multiple systems. For example, one or more functions of the music generation system 800 can be performed by one or more servers, and one or more functions of the music generation system 800 can be performed by one or more client devices. The one or more servers and/or one or more client devices may generate, store, receive, and transmit any type of data used by the music generation system 800, as described herein.

In one implementation, the one or more client devices can include or implement at least a portion of the music generation system 800. In other implementations, the one or more servers can include or implement at least a portion of the music generation system 800. For instance, the music generation system 800 can include an application running on the one or more servers or a portion of the music generation system 800 can be downloaded from the one or more servers. Additionally or alternatively, the music generation system 800 can include a web hosting application that allows the client device(s) to interact with content hosted at the one or more server(s).

In some embodiments, a client device can accessing a webpage or other web application hosted at the one or more servers, hosting the music generation system. The user, or other entity, can provide the prompt and control data to the music generation system executing on the one or more servers. Upon receiving the request, the one or more servers can automatically perform the methods and processes described above to generate music. The one or more servers can provide all or portions of the generated audio to the client device for playback to the user.

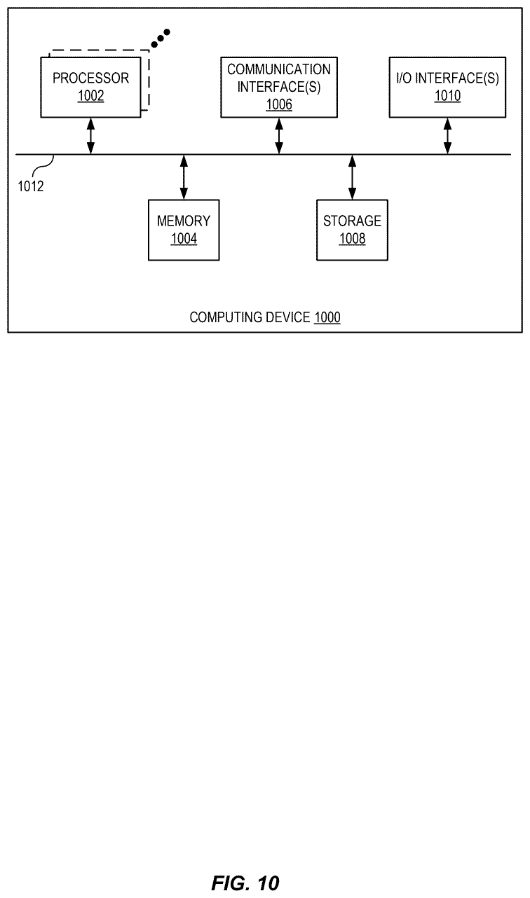

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 10. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 10.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 10.

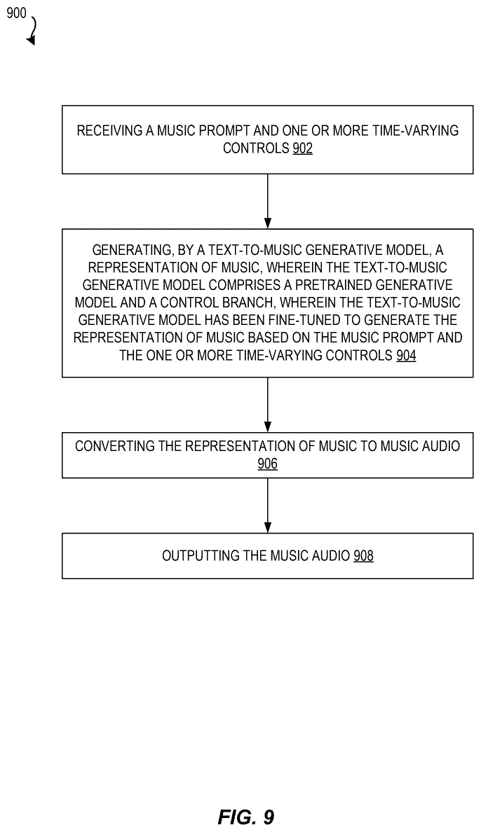

FIGS. 1-8, the corresponding text, and the examples, provide a number of different systems and devices that enable text-to-music generation. In addition to the foregoing, embodiments can also be described in terms of flowcharts comprising acts and steps in a method for accomplishing a particular result. For example, FIG. 9 illustrates a flowchart of an exemplary method in accordance with one or more embodiments. The method described in relation to FIG. 9 may be performed with fewer or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart 900 of a series of acts in a method of music generation in accordance with one or more embodiments. In one or more embodiments, the method 900 is performed in a digital medium environment that includes the music generation system 800. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of receiving a music prompt and one or more time-varying controls. As discussed, the music prompt may include a text prompt defining global characteristics of the music to be generated, such as mood, genre, etc. In some embodiments, the time-varying controls may include images of time-varying features, such as melody, rhythm, dynamics, etc. In some embodiments, control audio may be received and at least one of the time varying controls may be extracted from the audio, as discussed.

As illustrated in FIG. 9, the method 900 also includes an act 904 of generating, by a text-to-music generative model, a representation of music, wherein the text-to-music generative model comprises a pretrained generative model and a control branch, wherein the text-to-music generative model has been fine-tuned to generate the representation of music based on the music prompt and the one or more time-varying controls.

In some embodiments, at least one portion of at least one time-varying control may be masked to create a masked time-varying control. As discussed, the mask may include obscuring a portion or portions of the time-varying control. The text-to-music model may be trained to generate music that matches the unmasked portions of the time-varying controls and improvises the time-varying features in the masked portions. In some embodiments, the at least one portion of the masked time-varying control includes a contiguous portion or multiple discontiguous portions. In some embodiments, the one or more time-varying controls includes at least one of an image representing a melody control, an image representing a dynamics control, or an image representing a rhythm control.

In some embodiments, the pretrained generative model is a diffusion model trained to generate the representation of music based on the music prompt. In some embodiments, the control branch includes a copy of a portion of the diffusion model. In some embodiments, the pretrained generative model receives the music prompt and the control branch receives the music prompt and the control branch receives the music prompt and the one or more time-varying controls.

As illustrated in FIG. 9, the method 900 also includes an act 906 of converting the representation of music to music audio. As discussed, the image representation may be a spectrogram. In some embodiments, the image representation may be converted to audio using a vocoder.

As illustrated in FIG. 9, the method 900 also includes an act 908 of outputting the music audio. For example, the user can play the audio and determine whether new audio should be generated based on, e.g., an updated prompt and/or time-varying controls.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the music generation system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a music prompt and one or more time-varying controls;
generating, by a text-to-music generative model, a representation of music, wherein the text-to-music generative model comprises a pretrained generative model and a control branch, wherein the text-to-music generative model has been fine-tuned to generate the representation of music based on the music prompt and the one or more time-varying controls;
converting the representation of music to music audio; and
outputting the music audio.

2. The method of claim 1, wherein receiving a music prompt and one or more time-varying controls, further comprises:
receiving control audio; and
extracting at least one time-varying control from the control audio.

3. The method of claim 1, further comprising:
masking at least one portion of at least one time-varying control to create a masked time-varying control.

4. The method of claim 3, wherein the at least one portion of the masked time-varying control includes a contiguous portion or multiple discontiguous portions.

5. The method of claim 1, wherein the one or more time-varying controls includes at least one of an image representing a melody control, an image representing a dynamics control, or an image representing a rhythm control.

6. The method of claim 1, wherein the pretrained generative model is a diffusion model trained to generate the representation of music based on the music prompt.

7. The method of claim 6, wherein the control branch includes a copy of a portion of the diffusion model.

8. The method of claim 7, wherein the pretrained generative model receives the music prompt and the control branch receives the music prompt and the control branch receives the music prompt and the one or more time-varying controls.

9. The method of claim 8, wherein the music prompt includes text data defining a mood or genre of the music.

10. The method of claim 1, wherein the representation of music is an image representation of music.

11. The method of claim 1, wherein the representation of music is a latent representation of music.

12. A non-transitory computer-readable medium storing executable instructions, which when executed by a processing device, cause the processing device to perform operations comprising:
receiving a music prompt and one or more time-varying controls;
generating, by a text-to-music generative model, a representation of music, wherein the text-to-music generative model comprises a pretrained generative model and a control branch, wherein the text-to-music generative model has been fine-tuned to generate the representation of music based on the music prompt and the one or more time-varying controls;
converting the representation of music to music audio; and
outputting the music audio.

13. The non-transitory computer-readable medium of claim 12, wherein the operation of receiving a music prompt and one or more time-varying controls, further comprises:
receiving control audio; and
extracting at least one time-varying control from the control audio.

14. The non-transitory computer-readable medium of claim 12, wherein the operations further comprise:
masking at least one portion of at least one time-varying control to create a masked time-varying control.

15. The non-transitory computer-readable medium of claim 14, wherein the at least one portion of the masked time-varying control includes a contiguous portion or multiple discontiguous portions.

16. The non-transitory computer-readable medium of claim 12, wherein the one or more time-varying controls includes at least one of an image representing a melody control, an image representing a dynamics control, or an image representing a rhythm control.

17. The non-transitory computer-readable medium of claim 12, wherein the pretrained generative model is a diffusion model trained to generate the representation of music based on the music prompt.

18. The non-transitory computer-readable medium of claim 17, wherein the control branch includes a copy of a portion of the diffusion model, and wherein the pretrained generative model receives the music prompt and the control branch receives the music prompt and the control branch receives the music prompt and the one or more time-varying controls.

19. A system comprising:
a memory; and
a processing device coupled to the memory, the processing device to perform operations comprising:
receiving a request to generate music, the request including a text prompt and one or more time-varying controls;
generating, by a text-to-music generative model, an image of a spectrogram of the music based on the text prompt and the one or more time-varying controls, wherein the text-to-music generative model comprises a pretrained generative model and a fine-tuned control branch to process the one or more time-varying controls;
converting the spectrogram to music audio using a vocoder; and
outputting the music audio.

20. The system of claim 19, wherein the operation of generating, by a text-to-music generative model, an image of a spectrogram of the music based on the text prompt and the one or more time-varying controls, wherein the text-to-music generative model comprises a pretrained generative model and a fine-tuned control branch to process the one or more time-varying controls further comprises:
generating the music such that a time varying feature of the generated music matches an unmasked portion of at least one time-varying control.
